(19) United States
(12) Patent Application Publication
(10) Pub. No.: US 2005/0147932 A1
(43) Pub. Date: Jul. 7, 2005

(54) Method for processing color motion picture print film

(75) Inventors: Brian H. Johnston, Pittsford, NY (US); Kathleen R.C. Gisser, Pittsford, NY (US)

Correspondence Address: Paul A. Leipold;Eastman Kodak Company, 343 State Street, Rochester, NY, 14650-2201, US

(73) Assignee: Eastman Kodak Company

(21) Appl. No.: 10/749,823

(22) Filed: Dec. 31, 2003

(51) Int. Cl. G03C 5/18

(52) U.S. Cl. 430/467

(57) ABSTRACT

A method for processing imagewise exposed silver halide light sensitive motion picture photographic print film elements, the method comprising: i) classifying imagewise exposed print film elements containing cyan, magenta and yellow dye-forming couplers present at levels sufficient to provide Visual densities of at least 3.3 when completely consumed as either a relatively high silver containing element or a relatively low silver containing element; ii) providing a developer solution comprising greater than 2.1 g/l Color Developing Agent CD-2, greater than 0.3 and less than 2.1 g/l of Sodium Bromide (Anhydrous), and a buffering agent to maintain pH in the range of from about 10 to about 12; iii) developing imagewise exposed print film elements which have been classified as relatively low silver containing elements in a development step wherein the exposed print film is first processed in the developer solution provided in step ii) above, and in a subsequent development amplification step wherein the exposed print film is processed in an amplifier solution comprising bromide salt and an oxidizing agent; and iv) developing imagewise exposed print film elements which have been classified as relatively high silver containing elements in a development step wherein the exposed print film is processed in the developer solution provided in ii) above. In preferred embodiments, elements which have been classified as relatively high silver containing elements and which have been imagewise developed in step iv) by processing in the developer solution provided in ii) are not subjected to a subsequent development amplification step as defined in step iii). The invention provides increased stability of development amplification processing solutions by the use of separate development and amplification baths. The invention also enables commercial operations of motion picture print film continuous processors to capture the advantages of development amplification, and permits flexibility of commercial operations to practice both amplified and unamplified processes with minimal disruption.

### FIELD OF THE INVENTION

The invention relates to a method for processing color motion picture print silver halide photographic films, and more particularly to such a method which may be used for processing color motion picture film which has relatively reduced silver levels designed for processing in a redox amplification development process, as well as color motion picture print film which has relatively high silver levels not requiring redox amplification processing.

### BACKGROUND

Color photographic silver halide materials are processed by a process which includes a color development step. In conventional color development, silver halide is reduced to metallic silver in the light-exposed areas and the oxidized color developer formed in this reaction then couples with a color coupler and forms image dye. In such conventional development, the maximum amount or dye produced is stoichiometrically proportional to the amount of silver halide reduced to metallic silver, and the type of dye-forming coupler employed. For so-called “2-equivalent” couplers, two mols of silver are required to form one mol of dye. For “4-equivalent” couplers, four mols of silver are required to form one mol dye.

In recent years there has been a trend to reduce the amount of silver contained in photographic materials, while still generating sufficient dye images. There are various reasons why this has been done and these include reducing costs, reducing the thickness of silver halide emulsion layers, gaining sharpness, and improving the environmental impact. One class of low silver photographic materials are color materials intended for redox amplification processes wherein the developed silver acts as a catalyst to the formation of dye image. Redox amplification processes have been described, for example, in U.S. Pat. Nos. 3,674,490, 3,765,891, 3,822,129, 3,748,138, 4,088,486 and 4,954,425, and in Research Disclosure, December 1973, Page 109 No. 11660. In such processes, low silver containing color materials are developed to produce a silver image and then treated with an amplifying solution to form a dye image. The amplifying solution is usually combined with the developer to form the so-called developer-amplifier solution. The developer-amplifier solution contains a reducing agent, for example a color developing agent, and an oxidizing agent which will oxidize the color developing agent in the presence of the silver image which acts as a catalyst. The oxidized color developer reacts with a color coupler to form the image dye. During amplification, the silver image is used to produce greater quantities of oxidized developer by the action of the oxidizing agent on the catalytic surface provided by the silver image. The extra dye formed is said to amplify or intensify the image. Hence smaller amounts of silver halide in the photographic material are needed while still providing the desired image dye density. The amount of image produced in redox amplification processes depends on the time of treatment or the availability of color coupler, and is less dependent on the amount of silver in the image as is the case in conventional color development processes. Examples of suitable oxidizing agents include peroxy compounds including hydrogen peroxide, cobalt (III) complexes including cobalt hexamine complexes, and periodates. Mixtures of such compounds can also be used.

A serious problem with developer-amplifier solutions, however, is their stability. Because they contain both an oxidizing agent (e.g., the peroxide) and a reducing agent (the color developing agent), they may react together spontaneously leading to loss of activity in a short period of time. Various means to stabilize the developer-amplifier processing solution have been described. Such means include the use of metal sequestrants as described in U.S. Pat. No. 5,702,873 which reduces the degree to which metal ions catalyze the reaction of peroxide, the use of high pH as described in U.S. Pat. No. 6,114,101 which slows the oxidation reaction, the use of borate and silicate buffers as described in U.S. Pat. Nos.5,667,947 and 5,731,135, zinc ions as described in U.S. Pat. No. 5,821,037 and the use of hydroxylamine sulfate, as the anti-oxidant or preservative agent as described in U.S. Pat. No. 6,303,279.

Alternatively, means to overcome the instability of the developer-amplifier solution include modifications to commercial photoprocessing tanks and equipment, for example the use of low volume thin tanks has been described in U.S. Pat. Nos. 5,387,499, 5,361,114, 5,382,995, 5,319,410 and 5,475,461 that require use of less than 1 liter and as little as 100 ml of solution permitting the use of unstable processing chemistry. Indeed, substantial effort has been applied to address the constraints bought on by the use of a developer-amplifier that effective solutions employ configurations where the ratio of tank volume to maximum area of material accomodatable therein (i.e., maximum path length times width of material) is less than 11 dm³/m² and preferably less than 3 dm³/m².

An alternative to a single solution is where the developer is used in a first bath followed by an amplifier bath. The amount of dye formed in such a system, however, is limited by the amount of color developing agent carried over into the second bath from the first. In order to provide sufficient color developer solely through carry-over, it would be necessary to have a level of color developing agent in the developer bath that would be too high for continuous running. U.S. Pat. No. 5,324,624 teaches the use of a developer bath followed by a developer-amplification bath. While not completely eliminating stability problems, use of the described process has the effect of lowering the needed concentration of the components of the developer-amplifier and contributing to improved solution stability. In this way low silver reflective color print materials are developed with 4-N-ethyl-N-(beta-methanesulfonamidoethyl)-o-toluidine sesquisulfate (color developer CD-3) as the specific color developing agent under conditions suitable for the commercial use of a color paper minilab photoprocessor.

Motion picture print film, the film that is shown in movie theaters, commonly employs an optical analog soundtrack along an edge of the film. During projection of the motion picture images, a light source illuminates the analog soundtrack and a photosensor senses the light passing through and modulated by the soundtrack to produce an audio signal that is sent to amplifiers of the theater sound system. While the most common soundtracks are of the “variable area” type wherein the signal is recorded in the form of a varying ratio of opaque to relatively clear area along the soundtrack, “variable density” soundtracks are also known wherein the absolute density is uniformly varied along the soundtrack. Common sound systems incorporate a photodiode in the projector whose radiant sensitivity peaks at approximately 800-950 nm (depending on the type of photodiode), which detects the predominant infra-red (IR) radiation emitted by common tungsten lamps.

A dye soundtrack may be formed in color motion picture film in accordance with conventional exposing and color development processing. Such dye soundtracks may be formed in multiple photosensitive emulsion layers of the motion picture film, or may be restricted to a single emulsion layer as set forth in U.S. Pat. No. 2,176,303. In order to provide effective modulation of common projector soundtrack illumination light, however, motion picture print film is typically processed according to a complex system wherein the optical analog soundtrack area of the print film is developed differently from the picture image frame area so that a silver image is left in the soundtrack area of the film, whereas all the silver is removed in the picture frame area, leaving only a dye image. The silver image may be reformed selectively in the soundtrack area of the film through selective application of a second developer solution after initial uniform color development (which develops exposed silver halide in both the picture area and soundtrack area up to silver metal and generates image dye), stop bath and fixer (arrests development and removes undeveloped silver halide), and bleach (converts exposed, developed silver back to silver halide in both the picture area and soundtrack area) steps. The second development step typically comprises application of a thick, viscous solution of a conventional black and white developer with a cellulose compound such as nitrosyl in a stripe solely onto the soundtrack area of the film, causing the silver halide in the soundtrack area to be selectively developed back into silver metal, while not affecting the silver halide in the image area. A subsequent fixing step then removes the silver halide from the image area, while leaving a silver image corresponding to the soundtrack exposure. Various other techniques are also known for retaining silver in the soundtrack area, but all such approaches invariably entail certain processing disadvantages, such as critical reactant concentration control and area-selective reactant application requirements. Examples of such techniques, e.g., are set forth in U. S. Pat. Nos. 2,220,178, 2,341,508, 2,763,550, 3,243,295, 3,705,799, and 4,139,382.

U.S. Pat. No. 4,219,615 suggests the use of a color amplification development process for photographic films which contain reduced silver levels in some, but not all of the emulsion layers of the element, such that a sound track with a high silver image may be formed in at least one layer of the element upon processing. While the objective of providing photographic films with overall reduced silver levels is obtained to a degree, the use of a film with color records having both reduced and conventional high silver levels introduces further complexities into color balancing requirements, as the different color records may react substantially differently to changes in process conditions. Further, the proposed process and photographic elements do not eliminate the need for special processing in the sound track area relative to the scene image areas of the exposed film.

It has also been shown that where development amplification processes are designed for processing low silver color papers, for example those having about 200 mg/m² or less of silver, such processes generally cannot be used to process conventional color papers that typically contain from 500 to 700 mg/m² because gross overamplification would occur. Similar compatibility problems would be expected for processing of conventional relatively high silver level motion picture print films with an amplified development process designed specifically for use with relatively low silver level color print films. U.S. Pat. No. 5,871,891 teaches a means to process both low silver and conventional higher silver photographic recording materials using the same processing apparatus, where the developer solution is modified depending upon the type of photographic material being processed. While such technique may be practical for use in processing of color paper materials when using processing apparatus employing relatively low development solution volume, it would not be practical for use in processing of motion picture color print films, which are typically processed in apparatus employing relatively high solution volumes.

It would be desirable to provide a method for processing color motion picture print silver halide photographic films employing a common developer solution, which may be used for processing color motion picture films which have relatively reduced silver levels designed for processing in a redox amplification development process, as well as color motion picture print films which have relatively high silver levels not requiring redox amplification processing.

### SUMMARY OF THE INVENTION

One embodiment of the invention is directed towards a method for processing imagewise exposed silver halide light sensitive motion picture photographic print film elements, the method comprising
i) classifying imagewise exposed print film elements containing cyan, magenta and yellow dye-forming couplers present at levels sufficient to provide Visual densities of at least 3.3 when completely consumed as either a relatively high silver containing element or a relatively low silver containing element;
ii) providing a developer solution comprising greater than 2.1 g/l Color Developing Agent CD-2, greater than 0.3 and less than 2.1 g/l of Sodium Bromide (Anhydrous), and a buffering agent to maintain pH in the range of from about 10 to about 12;
iii) developing imagewise exposed print film elements which have been classified as relatively low silver containing elements in a development step wherein the exposed print film is first processed in the developer solution provided in step ii) above, and in a subsequent development amplification step wherein the exposed print film is processed in an amplifier solution comprising bromide salt and an oxidizing agent; and
iv) developing imagewise exposed print film elements which have been classified as relatively high silver containing elements in a development step wherein the exposed print film is processed in the developer solution provided in ii) above.

In preferred embodiments of the invention, print film elements which have been classified as relatively high silver containing elements and which have been imagewise developed in step iv) by processing in the developer solution provided in ii) are not subjected to a subsequent development amplification step as defined in step iii). The invention provides increased stability of development amplification processing solutions by the use of separate development and amplification baths. The invention also enables commercial operations of motion picture print film continuous processors to capture the advantages of development amplification, and permits flexibility of commercial operations to practice both amplified and unamplified processes with minimal disruption.

### DETAILED DESCRIPTION

In motion picture color printing, there are usually three records to record simultaneously in the image area frame region of a print film, i.e., red, green and blue. The original record to be reproduced is preferably an image composed of sub-records having radiation patterns in different regions of the spectrum. Typically it will be a multicolor record composed of sub-records formed from cyan, magenta and yellow dyes. The principle by which such materials form a color image are described in James, The Theory of the Photographic Process, Chapter 12, Principles and Chemistry of Color Photography, pp 335-372, 1977, Macmillan Publishing Co. New York, and suitable materials useful to form original records are described in Research Disclosure, December, 1987, Item 17643, published by Industrial Opportunities Ltd., Homewell Havant, Hampshire, P09 1EF, United Kingdom, and Research Disclosure, September 1994, Item 36544, published by Kenneth Mason Publications, Ltd., Emsworth, Hampshire P010 7DQ, England. Materials in which such images are formed can be exposed to an original scene in a camera, or can be duplicates formed from such camera origination materials, such as records formed in color negative intermediate films such as those identified by the tradenames Eastman Color Intermediate Films 2244, 5244 and 7244. The peak absorptions for such films are in the blue region of the spectrum at about 440 nm, in the green region of the spectrum at about 540 nm, and in the red region of the spectrum at about 680 nm.

Motion picture print films which may be processed in accordance with the invention in preferred embodiments comprise a support bearing on one side thereof: a blue color sensitive, yellow dye image-forming record comprising at least one blue-sensitive (approx. 380-500 nm) silver halide emulsion having associated therewith yellow dye-forming coupler; a red color sensitive, cyan dye image-forming record comprising at least one red-sensitive (approx. 600-760 nm) silver halide emulsion having associated therewith cyan dye-forming coupler; and a green color sensitive, magenta dye image-forming record comprising at least one green-sensitive (approx. 500-600 nm) silver halide emulsion having associated therewith magenta dye-forming coupler. Each of the cyan, magenta, and yellow image forming records may be comprised of a single light-sensitive layer, a pack of two light-sensitive layers with one being more light sensitive and the other being less light-sensitive, or a pack of three or more light-sensitive layers of varying light-sensitivity. These layers can be combined in any order depending upon the specific features designed in the photographic element. The element can contain additional layers, such as filter layers, interlayers, overcoat layers, subbing layers, antihalation layers, antistatic layers, and the like.

In the following discussion of suitable materials for use in the emulsions and elements that can be used in conjunction with the invention, reference will be made to Research Disclosure, September 1994, Item 36544, available as described above, which will be identified hereafter by the term “Research Disclosure.” The contents of the Research Disclosure, including the patents and publications referenced therein, are incorporated herein by reference, and the Sections hereafter referred to are Sections of the Research Disclosure, Item 36544.

Suitable silver halide emulsions and their preparation as well as methods of chemical and spectral sensitization are described in Sections I, and III-IV. Vehicles and vehicle related addenda are described in Section II. Dye image formers and modifiers are described in Section X. Various additives such as UV dyes, brighteners, luminescent dyes, antifoggants, stabilizers, light absorbing and scattering materials, coating aids, plasticizers, lubricants, antistats and matting agents are described, for example, in Sections VI-IX. Layers and layer arrangements, color negative and color positive features, scan facilitating features, supports, exposure and processing can be found in Sections XI-XX.

Photographic light-sensitive elements may utilize silver halide emulsion image forming layers wherein chloride, bromide and/or iodide are present alone or as mixtures or combinations of at least two halides. The combinations significantly influence the performance characteristics of the silver halide emulsion. In accordance with preferred embodiments of the invention, each of the light sensitive silver halide emulsions employed in the image forming records of the print films to be processed have an average grain size equivalent circular diameter (ECD) of less than 1 micrometer (where the ECD of a grain is the diameter of a circle having the area equal to the projected area of a grain) and comprise at least 50 mol percent chloride (preferably at least 80 mol %, and more preferably at least 90 mol % chloride), based on silver. The ECDs of silver halide emulsion grains employed in the color print film elements are preferably less than 0.60 micron (more preferably less than 0.4 micron) in red and green sensitized layers and less than 1.0 micron (more preferably less than 0.8 micron) in blue sensitized layers. Such fine grain emulsions used in print elements generally have an aspect ratio of less than 1.3, where the aspect ratio is the ratio of a grain's ECD to its thickness, although higher aspect ratio grains may also be used. Such grains may take any regular shapes, such as cubic, octahedral or cubo-octahedral (i.e., tetradecahedral) grains, or the grains can take other shapes attributable to ripening, twinning, screw dislocations, etc. Typically, print element emulsions grains are bounded primarily by {100} crystal faces, since {100} silver chloride grain faces are exceptionally stable. Specific examples of high chloride emulsions used for preparing photographic prints are provided in U.S. Pat. Nos. 4,865,962; 5,252,454; and 5,252,456, the disclosures of which are here incorporated by reference.

Such relatively small, relatively high chloride emulsions are preferred for low granularity performance and environmental processing advantages. As explained in Atwell, U.S. Pat. No. 4,269,927, e.g., silver halide with a high chloride content possesses a number of highly advantageous characteristics. For example, high chloride silver halides are more soluble than high bromide silver halide, thereby permitting development to be achieved in shorter times. Furthermore, the release of chloride into the developing solution has less restraining action on development compared to bromide and iodide and this allows developing solutions to be utilized in a manner that reduces the amount of waste developing solution. Since print films are intended to be exposed by a controlled light source, the imaging speed gain which would be associated with high bromide emulsions offers little benefit for such print films.

Photographic print films which comprise relatively small grain, high chloride emulsions (e.g., emulsions having average grain size equivalent circular diameters of less than about 1 micron and halide contents of greater than 50 mole % chloride) as discussed above in order to optimize print image quality and enable rapid processing typically result in relatively low speed photographic elements in comparison to camera negative origination films. Low speed is compensated for by the use of relatively high intensity print lamps or lasers for exposing such print elements. For comparison purposes, it is noted that motion picture color print films, e.g., when rated using the same international standards criteria used for rating camera negative films, would typically have an ISO speed rating of less than 10, which is several stops slower than the slowest camera negative films in current use.

Couplers that may be used in the elements processed in accordance with the invention can be defined as being 4-equivalent or 2-equivalent depending on the number of atoms of Ag⁺ required to form one molecule of dye. A 4-equivalent coupler can generally be converted into a 2-equivalent coupler by replacing a hydrogen at the coupling site with a different coupling-off group. Coupling-off groups are well known in the art. Such groups can modify the reactivity of the coupler. Such groups can advantageously affect the layer in which the coupler is coated, or other layers in the photographic recording material, by performing, after release from the coupler, functions such as dye formation, dye hue adjustment, development acceleration or inhibition, bleach acceleration or inhibition, electron transfer facilitation, color correction and the like. Representative classes of such coupling-off groups include, for example, chloro, alkoxy, aryloxy, hetero-oxy, sulfonyloxy, acyloxy, acyl, heterocyclyl, sulfonamido, mercaptotetrazole, benzothiazole, alkylthio (such as mercaptopropionic acid), arylthio, phosphonyloxy and arylazo. These coupling-off groups are described in the art, for example, in U.S. Pat. Nos. 2,455,169; 3,227,551; 3,432,521; 3,476,563; 3,617,291; 3,880,661; 4,052,212 and 4,134,766; and in U.K. Patents and published Application Nos. 1,466,728; 1,531,927; 1,533,039; 2,006,755A and 2,017,704A, the disclosures of which are incorporated herein by reference.

Image dye-forming couplers may be included in print film elements such as couplers that form cyan dyes upon reaction with oxidized color developing agents which are described in such representative patents and publications as: U.S. Pat. Nos. 2,367,531; 2,423,730; 2,474,293; 2,772,162; 2,895,826; 3,002,836; 3,034,892; 3,041,236; 4,883,746 and “Farbkuppler-Eine Literature Ubersicht,” published in Agfa Mitteilungen, Band III, pp. 156-175 (1961). Preferably such couplers are phenols and naphthols that form cyan dyes on reaction with oxidized color developing agent. Also preferable are the cyan couplers described in, for instance, European Patent Application Nos. 544,322; 556,700; 556,777; 565,096; 570,006; and 574,948.

Couplers that form magenta dyes upon reaction with oxidized color developing agent which can be incorporated in elements are described in such representative patents and publications as: U.S. Pat. Nos. 2,600,788; 2,369,489; 2,343,703; 2,311,082; 2,908,573; 3,062,653; 3,152,896; 3,519,429 and “Farbkuppler-Eine Literature Ubersicht,” published in Agfa Mitteilungen, Band III, pp. 126-156 (1961). Preferably such couplers are pyrazolones, pyrazolotriazoles, or pyrazolobenzimidazoles that form magenta dyes upon reaction with oxidized color developing agents. Especially preferred couplers are 1H-pyrazolo[5,1-c]-1,2,4-triazole and 1H-pyrazolo[1,5-b]-1,2,4-triazole. Examples of 1H-pyrazolo[5,1-c]-1,2,4-triazole couplers are described in U.K. Patent Nos. 1,247,493; 1,252,418; 1,398,979; U.S. Pat. Nos. 4,443,536; 4,514,490; 4,540,654; 4,590,153; 4,665,015; 4,822,730; 4,945,034; 5,017,465; and 5,023,170. Examples of 1H-pyrazolo[1,5-b]-1,2,4-triazoles can be found in European Patent Applications 176,804; 177,765; U.S. Pat. Nos. 4,659,652; 5,066,575; and 5,250,400.

Couplers that form yellow dyes upon reaction with oxidized color developing agent and which are useful in elements are described in such representative patents and publications as: U.S. Pat. Nos. 2,875,057; 2,407,210; 3,265,506; 2,298,443; 3,048,194; 3,447,928 and “Farbkuppler-Eine Literature Ubersicht,” published in Agfa Mitteilungen, Band III, pp. 112-126 (1961). Such couplers are typically open chain ketomethylene compounds. Also preferred are yellow couplers such as described in, for example, European Patent Application Nos. 482,552; 510,535; 524,540; 543,367; and U.S. Pat. No. 5,238,803.

To control the migration of various components coated in a photographic layer, including couplers, it may be desirable to include a high molecular weight hydrophobe or “ballast” group in the component molecule. Representative ballast groups include substituted or unsubstituted alkyl or aryl groups containing 8 to 40 carbon atoms. Representative substituents on such groups include alkyl, aryl, alkoxy, aryloxy, alkylthio, hydroxy, halogen, alkoxycarbonyl, aryloxcarbonyl, carboxy, acyl, acyloxy, amino, anilino, carbonamido (also known as acylamino), carbamoyl, alkylsulfonyl, arysulfonyl, sulfonamido, and sulfamoyl groups wherein the substituents typically contain 1 to 40 carbon atoms. Such substituents can also be further substituted. Alternatively, the molecule can be made immobile by attachment to a polymeric backbone.

It may be useful to use a combination of couplers any of which may contain known ballasts or coupling-off groups such as those described in U.S. Pat. Nos. 4,301,235; 4,853,319 and 4,351,897.

In addition to the light sensitive dye forming layers, the print films processed in accordance with the invention may include further features and layers as are known in the art. For example, antihalation and antistatic layers may be included on either side of the support, along with additional conventional interlayers and overcoat layers. Preferred supports for the print films comprise transparent polymeric films, such as cellulose nitrate and cellulose esters (such as cellulose triacetate and diacetate), polycarbonate, and polyesters of dibasic aromatic carboxylic acids with divalent alcohols such as poly(ethylene terephthalate). It is further specifically contemplated that the print elements may comprise antihalation and antistatic layers and associated compositions as set forth in U.S. Pat. Nos. 5,650,265, 5,679,505, and 5,723,272, the disclosures of which are incorporated by reference herein. Alternatively, an antihaltion comprising a hydrophilic colloid and silver as described in U.S. Pat. No. 5,753,402 may be employed. Antistatic layers comprising polythiophene which exhibit a conductivity shift upon processing such as described in U.S. Pat. No. 6,440,654, the disclosure of which is incorporated by reference herein, are also specifically contemplated. If desired, the print films can be used in conjunction with an applied magnetic layer as described in Research Disclosure, November 1992, Item 34390 published by Kenneth Mason Publications, Ltd., Dudley House, 12 North Street, Emsworth, Hampshire P010 7DQ, ENGLAND.

In accordance with the invention, imagewise exposed silver halide light sensitive motion picture photographic print film elements are first classified as either a relatively high silver containing element or a relatively low silver containing element, relatively low silver containing elements are developed in a development step employing a specified provided developer solution (comprising greater than 2.1 g/l Color Developing Agent CD-2, greater than 0.3 and less than 2.1 g/l of Sodium Bromide (Anhydrous), and a buffering agent to maintain pH in the range of from about 10 to about 12) and in a subsequent development amplification step wherein the exposed print film is processed in an amplifier solution (comprising bromide salt and an oxidizing agent), and relatively high silver containing elements are developed in the same provided developer solution employed for development of relatively low silver elements. In accordance with preferred embodiments, print films having a total silver level of at least 1350 mg/m² are classified as relatively high silver containing elements, and print films having a total silver level of less than 1350 mg/m² are classified as relatively low silver containing elements.

The color developing compositions used in this invention specifically employ KODAK Color Developing Agent CD-2 (N,N-diethyl p-phenylenediamine sulfate) at a concentration of greater than 2.1 g/l, and greater than 0.3 and less than 2.1 g/l of sodium bromide. Lower levels of color developer, or lower or higher levels of sodium bromide, have been found to result in either inadequate dye formation (lower than desired maximum density) or excessive fog (elevated minimum density) upon processing of either conventional relatively high silver films without development amplification or of relatively low silver films with development amplification under other practical processing constraints. In accordance with preferred embodiments, in order to more effectively enable generation of preferred maximum visual densities of at least 3.3, more preferably at least 3.6 and most preferably of at least 3.8, while maintaining visual minimum densities of below 0.10, the developer solution employed in accordance with the invention preferably comprises at least 2.9 g/l, and more preferably at least 3.1 g/l, of Color Developer Agent CD-2, and also preferably comprises from 0.5 to 1.7 g/l, more preferably from 0.5 to 1.3 g/l, of sodium bromide. The developer solution is also buffered to maintain pH in the range of from about 10 to about 12, as lower pH may reduce developer activity and higher pH may be unpractical. Sodium carbonate is a preferred buffering agent, although other conventional buffering agents may be employed.

In order to protect the color developing agent, one or more antioxidants may be included in the developer solution at a level sufficient to prevent oxidation, and a sulfite compound (such as sodium sulfite, potassium sulfite, sodium bisulfite and potassium metabisulfite) is preferably employed for such purpose. Additional antioxidant which may be employed (in place or in addition to sulfite compounds) include hydroxylamine (and derivatives thereof), hydrazines, hydrazides, amino acids, ascorbic acid (and derivatives thereof), hydroxamic acids, aminoketones, mono- and polysaccharides, mono- and polyamines, quaternary ammonium salts, nitroxy radicals, alcohols, and oximes. Also useful as antioxidants are 1,4-cyclohexadiones. Mixtures of compounds from the same or different classes of antioxidants can also be used if desired.

After initial development with the specified color developer solution, print film elements which have been classified as relatively low silver level elements are further developed in a subsequent development amplification step wherein the exposed print film is processed in an amplifier solution comprising bromide salt and an oxidizing agent. As described in the prior art, examples of suitable oxidizing agents for use in redox amplified development processes include peroxy compounds including hydrogen peroxide, cobalt (III) complexes including cobalt hexamine complexes, and periodates. In accordance with a preferred embodiment, hydrogen peroxide is employed as the oxidizing agent in the amplifier solution. Preferred level of the oxidizing agent employed is at least about 1 g/l of a 30 wt % hydrogen peroxide aqueous solution (i.e., 0.3 g of H₂O₂ per liter of amplifier solution), although effective levels will depend upon the specific processing conditions employed. While levels of 1 g/l of 30 wt % hydrogen peroxide aqueous solution may be effective for continuous motion picture print film processors, e.g., higher minimum levels of greater than 5 g/l may be required for rack and tank batch film processing. Maximum levels of oxidizing agent employed is preferably less than about 40 g/l of 30 wt % hydrogen peroxide aqueous solution (i.e., 12 g H₂O₂ per liter of amplifier solution), as higher levels are generally wasteful. Bromide salt is required in the amplification bath for effective performance, but the minimum effective level has been found to be very low (e.g., about 0.01 g/l sodium bromide has provided effective performance), and depending upon the specific processing equipment employed may be achieved by carry-over from developer solution remaining on the film from the initial developer solution application step. In order to provide good performance even for the initially processed film samples, however, it is preferred to season the amplifier solution with a relatively small amount of the developer solution employed in the developer step, thereby introducing some bromide salt. Preferred levels of developer solution employed within the amplifier solution are from about 10 to 150 g/l. Note that when developer solution is added directly to the amplifier solution, a small amount of color developing agent will also be added (in addition to that provided by carry-over from developer solution remaining on the film during transfer from the developer bath to the amplifier bath). The presence of a small amount of directly added developing agent in the amplifier, while not required, may help reduce the loss of maximum density which may occur at higher bromide concentrations.

Imagewise exposed print film elements which have been classified as relatively low silver containing elements are preferably processed in the developer solution for at least 45 seconds (more preferably 45-90 seconds, and most preferably about 60 seconds) at a temperature of at least 90 F (more preferably from 90-102 F), and subsequently processed in the amplifier solution for at least 45 seconds (more preferably 45-90 seconds, and most preferably about 60 seconds) at a temperature of at least 90 F (more preferably from 90-102 F). Imagewise exposed print film elements which have been classified as relatively high silver containing elements are preferably processed in the developer solution for longer than 1 minute (more preferably from at least about 75 seconds to about 3 minutes, most preferably from at least about 2 to 3 minutes) at a temperature of at least 90 F (more preferably 90-102 F).

The specified provided developer solution is formulated for use with both relatively low silver print films requiring development amplification, as well as conventional relatively high silver print films not requiring development amplification. While the use of the development amplification step with conventional relatively high silver print films is not necessarily prohibited, it is an advantage of the invention that such step is not required for conventional high silver films in the process of the invention, and accordingly in preferred embodiments, print film elements which have been classified as relatively high silver containing elements and which have been imagewise developed in the provided developer solution are not subjected to the subsequent development amplification step required for processing of the relatively low silver elements.

A desilvering step is preferably performed after color development and amplification (when employed). Such step typically comprises a bleaching step to change the developed silver back to an ionic-silver state and a fixing step to remove the ionic silver from the light-sensitive material. The bleaching and fixing steps can be combined into a monobath bleach-fix step that can be used alone or in combination with the bleaching and the fixing step. If necessary, additional processing steps may be added, such as a washing step, a stopping step, a stabilizing step and a pretreatment step. The processing chemicals may be liquids, pastes, or solids, such as powders, tablets or granules, which may be dissolved to form processing solutions.

Further in accordance with preferred embodiments, the silver halide emulsions employed in the image forming records of relatively low silver print films processed in accordance with the invention in total preferably comprise from 500-1350 mg/m² silver (more preferably at least 800 and most preferably at least 900 mg/m², and more preferably at most 1250 and most preferably at most 1150 mg/m²), the cyan, magenta and yellow dye-forming couplers are preferably present at levels sufficient to provide visual densities of at least 3.3, more preferably at least 3.6 and most preferably at least 3.8 when completely consumed, the silver to dye-forming coupler stoichiometric equivalent molar ratio in each of the image-forming records is preferably less than 1.4 (more preferably less than 1.3, and most preferably less than 1.2), and the silver to dye-forming coupler stoichiometric equivalent molar ratio in at least one (and preferably at least two) of the image-forming records is preferably less than 1.0 (more preferably less than 0.9, most preferably less than 0.8). Such requirements define a unique motion picture print film which enables the production of desirably high density images with good granularity while employing low silver levels, as is more specifically described in concurrently filed, commonly assigned, copending U.S. Ser. No. ______ (Kodak Docket No. 84784), the disclosure of which is incorporated by reference herein. If silver levels are substantially below about 500 mg/m², visual densities of greater than 3.3 may be difficult to consistently and robustly be obtained even with amplified development processing. If the silver levels are above 1350 mg/m², as well as if the silver to dye-forming coupler stoichiometric ratios in one or more records are above the stated requirements, advantages of reduced silver levels are compromised. Visual densities of at least 3.3 (preferably at least 3.6, and more preferably at least 3.8) are required to provide sufficient black densities.

For the purposes of defining such preferred embodiment of the invention, the silver to dye-forming coupler stoichiometric ratio is defined as the ratio of the mols of silver halide to the moles of dye-forming coupler in a particular color record, divided by the equivalency of the dye-forming coupler (i.e., divided by 2 for 2-equivalent couplers, and divided by 4 for 4-equivalent couplers). Coupler equivalency is well known and established in the photographic art. In contrast to the present invention, in conventional print films intended for processing with conventional development, in order to account for development inefficiencies while also enabling coupling of substantially all imaging coupler employed, the silver to dye-forming coupler stoichiometric equivalent molar ratio in each of the image-forming records is typically greater than 1.0, and is further typically greater than 1.2 (commonly greater than 1.3 and frequently greater than 1.4) in at least one (and commonly in at least two) of the image-forming records. The above defined relatively low silver print films specifically employ relatively lower ratios of silver to the amount of image forming couplers present.

While conventional development processing of current commercially available color print films results in processing efficiency (E) values typically of less than 2.5 (where (E) values are calculated using the formula: E=(Dye Image Dmax)/(Silver coverage, g/m²)), in accordance with preferred embodiments of the present invention, relatively low silver color print films may be processed to provide processing efficiency (E) values of from 2.5 to 6.7, more preferably 2.5 to 5.0 and most preferably 3.0 to 5.0, while also maintaining the visual Dmin less than 0.1 for both relatively high silver containing elements processed in step iv) and relatively low silver containing elements processed in step iii), and the Equivalent Neutral Density (END) Dmax values for the cyan and yellow color records within 20% (more preferably within 15% and most preferably within 10%) of the END Dmax value for the green color record, which is desired for obtaining adequate color balance when developed print film images are projected with a xenon light source. END value for any particular dye color record is defined as the visual density that results when the other two dyes are added in quantities just sufficient to produce a neutral gray (see, e.g., “Procedures for Equivalent-Neutral-Density (END) Calibration of Color Densitometers Using a Digital Computer”, by Albert J. Sant, in the Photographic Science and Engineering, Vol. 14, Number 5, September-October 1970, pg. 356).

In accordance with a preferred embodiment, the processing of color print films in accordance with the invention may be performed after the image area frame region of the print film is conventionally imagewise exposed to produce a latent image in the red, green and blue light photosensitive layers of the print film, and a soundtrack region of the print film is exposed to produce a latent image corresponding to an analog soundtrack in at least one photosensitive layer of the print film. While the analog sound track may be recorded in more than one photosensitive layer of the print film (e.g., in both the red and green light sensitive layers as is conventionally practiced), in a preferred embodiment the exposure is limited to a single photosensitive layer through choice of soundtrack exposing light, filters, etc. In a most preferred embodiment, only the red light photosensitive cyan dye forming layer is exposed in accordance with the analog soundtrack. This may be conveniently done through use of a red light emitting diode laser in recording the soundtrack.

After the motion picture print films are exposed, they may be processed in accordance with one embodiment of the present invention to form a visible color image in the image area frame region of the film and a silverless “dye only” analog soundtrack. Such processing is particularly desirable for relatively low silver print film elements. Print film processing in accordance with such embodiment is characterized in that the soundtrack region of the film is not subjected to any specialized processing treatment relative to the image area frame region. As previously explained, the formation of a silver sound track on a color motion picture film in accordance with conventional practice requires additional special processing steps to retain the silver solely in the sound track region of the film, which are not needed in accordance with the present invention. Such processing is described for the Kodak ECP-2D Process, e.g., in Kodak Publication No. H-24, Manual For Processing Eastman Color Films, the disclosure of which is hereby incorporated by reference. Such previously performed steps no longer needed in accordance with such embodiment include, e.g., soundtrack drying, soundtrack applicator, soundtrack developer, and soundtrack spray rinse steps. A dye only soundtrack is simply developed in the soundtrack region of the print film as the dye images are formed in the image area frame region.

Due to the spectral differences between the silver and the dye only soundtracks, in accordance with a further preferred embodiment, the projector systems currently used for films containing silver soundtracks are modified for use with motion picture print films exposed and processed to contain a dye-only soundtrack to improve the performance of the dye-only soundtrack. Most existing sound motion picture projectors incorporate a photodiode in the projector whose radiant sensitivity peaks at approximately 800-950 nanometers (depending on the type of photodiode) to detect the predominant infra-red (IR) radiation emitted by the tungsten lamp and modulated by the film's variable area silver soundtrack. A dye only sound track, however, will modulate light predominantly in the visible region of the spectrum. Although the photodiodes have some sensitivity in the visible range (approximately 380-760 nanometers) of the radiation spectrum, their lower sensitivity in this range, coupled with the lower emission of the light source in the visible range results in a very low input to the sound amplifier. The situation is further aggravated by the fact that the density range between the “clear” minimum density (Dmin) area and the “opaque” maximum density (Dmax) area of a variable area analog soundtrack is less for the dye only soundtrack. If the signal is too low for the amplification stage to operate properly (e.g. signal-to-noise loss), the sound quality will be degraded.

Improved performance for the dye-only soundtracks can be achieved, e.g., by using the modified soundtrack interface apparatus for a motion picture projectors as described in U.S. Pat. No. 5,483,306, the disclosure of which is hereby incorporated by reference. Alternatively, or additionally, improved performance for the dye-only soundtracks can be achieved by recording and developing the soundtrack in a single photosensitive layer of the print film, and recovering the signal from the dye only soundtrack using a narrow band (e.g., 10-30 nm bandwidth) light source the wavelength of which is chosen so as to coincide with the peak absorbance wavelength of the soundtrack dye. Where the cyan layer of the print film is used to record the soundtrack, e.g., a narrow band red light source would be used for reading the developed soundtrack. A red light emitting diode may be conveniently used for reading cyan dye-only soundtracks, e.g., as has been recently proposed by Dolby Laboratories in an announcement at the Association of Cinema and Video Laboratories (ACVL) Jun. 1-3, 1995 convention at Lake Tahoe, Nev. The use of such relatively monochromatic light sources for the soundtrack reader in combination with a single layer dye soundtrack maximizes the relative optical density difference between the dyed areas and the undyed transparent areas of the soundtrack while maintaining high contrast. While a conventional tungsten light source may perform poorly with a dye only soundtrack due to the relatively low signal generated in the solar cell of the soundtrack reader resulting from the poor modulation of the tungsten light by the image dyes, the use of a narrow monochromatic light source eliminates the presence of unmodulated light outside the absorbance spectrum of the dye only soundtrack striking the solar cell, thereby improving the modulation signal generated by the solar cell.

The following examples illustrate processing of photographic color print elements in accordance with the present invention, and comparison processing.

### EXAMPLE 1

This example demonstrates the typical range of visual Dmax, Dmin, Silver content, Efficiency, and Color Balance for conventional commercially available color print films 101-104 (employing relatively high total silver levels of at least 1350 mg/m²) and additional films 105-110 (defined below, having varying levels of total silver) when processed according to a standard (non-amplified) color print film process.

Photographic color print film Element 105 (total silver halide emulsion coverage 1471 mg/m², based on silver) was prepared according to the following formulation:

Protective Overcoat

| | |
|---|---|
| Gelatin | 976 |
| Polydimethylsiloxane lubricant (Dow Corning) | 16 |
| Polymethylmethacrylate beads | 16 |
| Spreading Aids | |

Green Emulsion Layer

| | |
|---|---|
| AgClBr cubic grain emulsion GE-1, 1.35% Br, 0.14 micron, | 68 |
| spectrally sensitized with green sensitizing dye GSD-1, | |
| 0.363 mmole/Ag mole, and green sensitizing dye GSD-2, | |
| 0.012 mmole/Ag mole. | |
| AgClBr cubic grain emulsion GE-2, 1.2% Br, 0.18 micron, | 316 |
| spectrally sensitized with green sensitizing dye GSD-1, | |
| 0.293 mmole/Ag mole, and green sensitizing dye GSD-2, | |
| 0.009 mmole/Ag mole. | |
| AgClBr cubic grain emulsion GE-3, 1.7% Br, 0.26 micron, | 57 |
| spectrally sensitized with green sensitizing dye GSD-1, | |
| 0.273 mmole/Ag mole, and green sensitizing dye GSD-2, | |
| 0.008 mmole/Ag mole. | |
| Magenta Dye Forming Coupler M-1 | 648 |
| Green Filter Dye GFD-2 | 54 |
| Oxidized Developer Scavenger Scav-1 | 16 |
| Gelatin | 1426 |

Interlayer

| | |
|---|---|
| Oxidized Developer Scavenger Scav-1 | 48 |
| Gelatin | 610 |
| Spreading aids | |

Red Emulsion Layer

| | |
|---|---|
| AgClBr cubic grain emulsion RE-1, 0.8% Br, 0.14 micron, | 60 |
| spectrally sensitized with red sensitizing dye RSD-1, | |
| 0.042 mmole/Ag mole. | |
| AgClBr cubic grain emulsion RE-2, 0.9% Br, 0.18 micron, | 218 |
| spectrally sensitized with red sensitizing dye RSD-1, | |
| 0.044 mmole/Ag mole. | |
| AgClBr cubic grain emulsion RE-3, 0.9% Br, 0.26 micron, | 122 |
| spectrally sensitized with red sensitizing dye RSD-1, | |
| 0.050 mmole/Ag mole. | |
| Cyan dye forming coupler C-1 | 888 |
| Red Absorber Dye | 63 |
| Gelatin | 2859 |

Interlayer

| | |
|---|---|
| Oxidized Developer Scavenger Scav-1 | 48 |
| Gelatin | 610 |
| Spreading aids | |

Blue Emulsion Layer

| | |
|---|---|
| AgClBr cubic grain emulsion BE-1, 0.4% Br, 0.40 micron, | 126 |
| spectrally sensitized with blue sensitizing dye BSD-1, | |
| 0.151 mmole/Ag mole and blue sensitizing dye BSD-2, | |
| 0.149 mmole/Ag mole. | |
| AgClBr cubic grain emulsion BE-2, 0.5% Br, 0.50 micron, | 297 |
| spectrally sensitized with blue sensitizing dye BSD-1, | |
| 0.219 mmole/Ag mole and blue sensitizing dye BSD-2, | |
| 0.217 mmole/Ag mole. | |
| AgClBr cubic grain emulsion BE-3, 0.3% Br, 0.90 micron, | 208 |
| spectrally sensitized with blue sensitizing dye BSD-1, | |
| 0.124 mmole/Ag mole and blue sensitizing dye BSD-2, | |
| 0.122 mmole/Ag mole. | |
| Yellow Coupler (Y-1) | 1315 |
| Blue filter dye BFD-1 | 30 |
| Yellow Preformed Dye YPD-1 | 7 |
| Gelatin | 2395 |

Antihalation Layer

| | |
|---|---|
| Antihalation Filter Dye AFD-1 | 56 |
| Antihalation Filter Dye AFD-2 | 129 |
| Gelatin | 759 |
| Spreading aids | |

Support

Transparent polyethylene terephthalate support with polyurethane
overcoated Baytron P ™ (available from Bayer Corporation)
antistatic layer on the back of the film base which provides
process surviving antistatic properties.

The following structures represent compounds utilized in the above described photographic element.

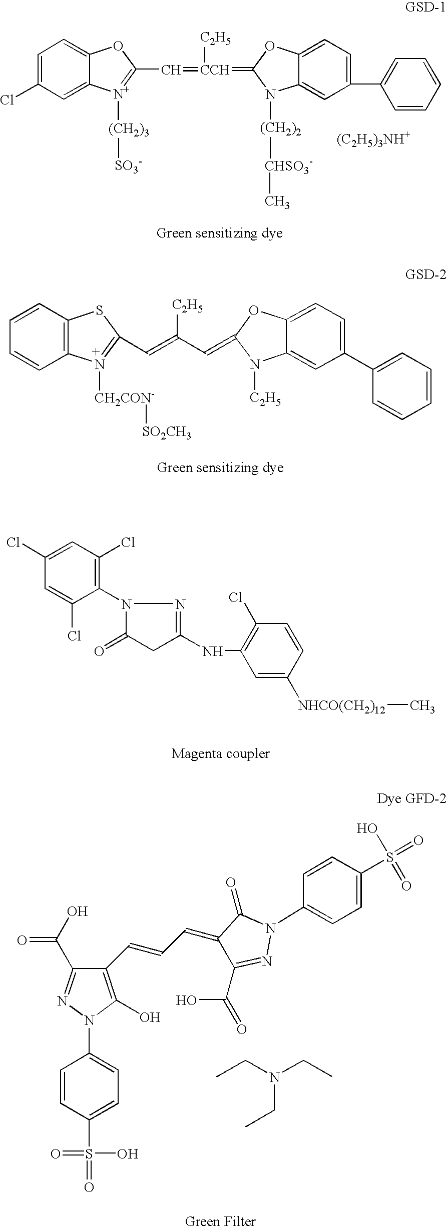

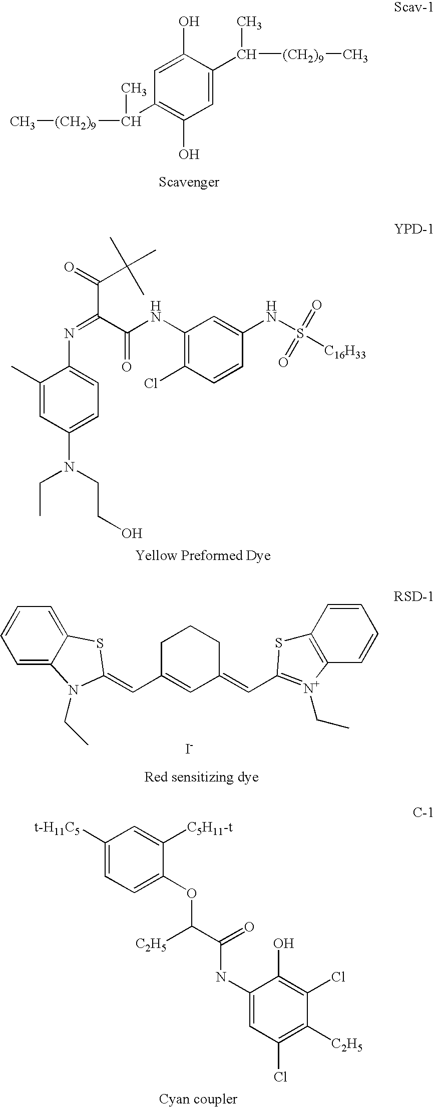

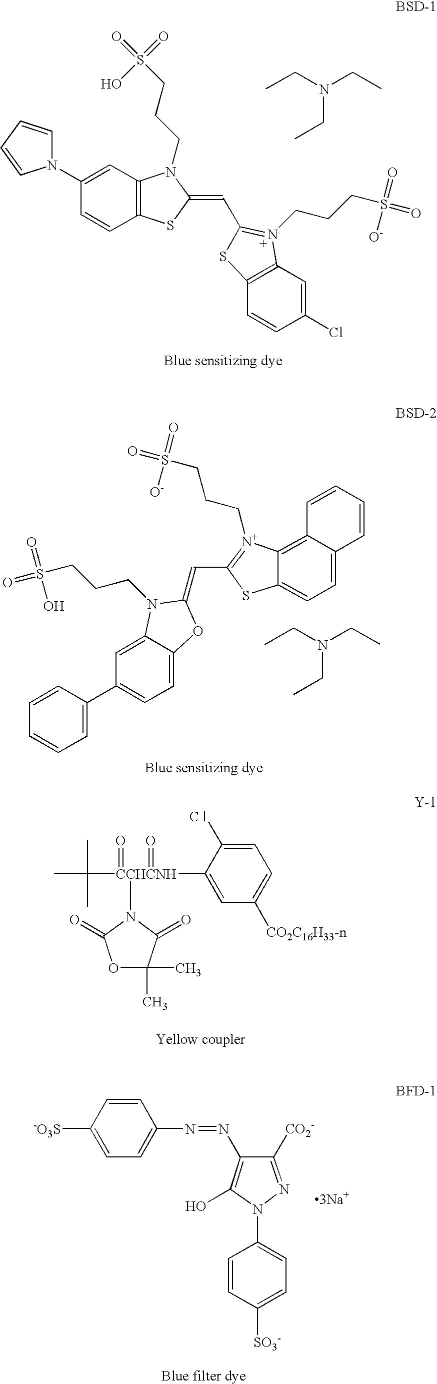

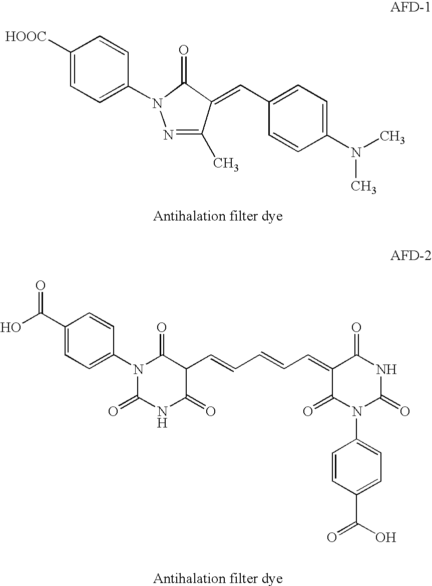

Photographic color print film Elements 106-109 (total silver halide emulsion coverage 500-1350 mg/m², based on silver) and Element 110 (total silver halide emulsion coverage 490 mg/m², based on silver) were prepared similarly to Element 105, but by varying the silver levels, coupler level and emulsion levels as indicated in Table 1A below:

TABLE 1A
(Laydowns in mg/m2)

| | Green | | Red | | Blue | |
|---|---|---|---|---|---|---|
| | Emulsion, | | Emulsion, | | Emulsion, | |
| | (Percent | | (Percent | | (Percent | |
| | GE-3, GE-2, | Magenta | RE-3, RE-2, | Cyan | BE-3, BE-2, | Yellow |
| Elem. | GE-1) | Coupler | RE-1) | Coup | BE-1) | Coupler |
| 105 | 442 | 648 | 400 | 888 | 632 | 1315 |
| | (15.5, 71.5, 13) | | (15, 54.5, 30.5) | | (20, 47, 33) | |
| 106 | 368 | 619 | 330 | 844 | 510 | 1258 |
| | (15.5, 71.5, 13) | | (15, 54.5, 30.5) | | (20, 49.5, 30.5) | |
| 107 | 344 | 648 | 311 | 888 | 491 | 1315 |
| | (15.5, 71.5, 13) | | (15, 54.5, 30.5) | | (20, 47, 33) | |
| 108 | 339 | 664 | 279 | 817 | 452 | 1304 |
| | (13, 80, 7) | | (0, 81.5, 18.5) | | (0, 80, 20) | |
| 109 | 245 | 648 | 222 | 888 | 351 | 1315 |
| | (15.5, 71.5, 13) | | (15, 54.5, 30.5) | | (20, 47, 33) | |
| 110 | 147 | 648 | 133 | 888 | 210 | 1315 |
| | (15.5, 71.5, 13) | | (15, 54.5, 30.5) | | (20, 47, 33) | |

Film element 101-110 were exposed for 1/500 s on a 1-B sensitometer with a 3200K light source and a 0-3 LogE step tablet, and then processed in the standard color print process ECP-2D as described in the Kodak Publication H-24, Module 9; using a persulfate bleach, omitting the first fix and subsequent wash, and without any sound track application. The ECP-2D process employed comprised a Color Developer step (3′), stop bath (40″), wash (40″), bleach accelerator (20″), persulfate bleach (40″), wash (40″), fix (40″), wash (1′), final rinse (10″), and then drying with hot air. Processing of the exposed elements is done with the color developing solution adjusted to 36.7° C. (98 F). The stopping, fixing, bleaching, washing, and final rinsing solution temperatures are ted to 26.7° C. (80 F).

The ECP-2D Color Developer comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Sodium sulfite (anhydrous) | 4.35 | g |
| Sodium bromide (anhydrous) | 1.72 | g |
| Sodium carbonate (anhydrous) | 17.1 | g |
| Kodak Color Developing Agent, CD-2 | 2.95 | g |
| Water to make 1 liter | | |
| pH @ 26.7° C. is 10.53 +/− 0.05 | | |

The visual Dmax was calculated from the Status A red, green and blue values according to the method in ISO Standard 5-3, using the standard Illuminant A. To calculate the color balance, the Status A densitometry was converted to Equivalent Neutral Densitometry using the method as described in the article “Procedures for Equivalent-Neutral-Density (END) Calibration of Color Densitometers Using a Digital Computer”, by Albert J. Sant, in the Photographic Science and Engineering, Vol. 14, Number 5, September-October 1970, pg. 356-362. The color balance percent is the percent difference of the END values for the highest density step in the cyan and magenta records, and in the yellow and magenta records. Silver content was measured by wavelength dispersive X-ray Fluorescence in unprocessed film. The efficiency is calculated by the following equation: (1000*Visual Dmax)/(Silver Content, mg/m²), and represents the amount of silver that is necessary to achieve a particular Visual Density. Higher efficiencies are desirable because the minimum amount of silver in the film may be used to reach the desired Dmax. Results for commercially available film Elements 101-104 are provided in Table 1B, and for film Elements 105-110 are provided in Table 1C.

TABLE 1B
Commercially Available Films processed in the ECP-2D Process

| | | | | | Color | Color |
|---|---|---|---|---|---|---|
| | | | | | Balance | Balance |
| | | Silver | | Visual | (cyan/ | (yellow/ |
| | Visual | Content | | Dmin | magenta) | magenta) |
| Elem. | Dmax | (mg/m²) | Efficiency | <0.1 | percent | percent |
| 101 | 3.80 | 1636 | 2.32 | Y | 1.0 | 1.0 |
| 102 | 4.75 | 2389 | 1.98 | Y | 0.4 | 2.0 |
| 103 | 3.61 | 1453 | 2.48 | Y | 9.0 | 6.0 |
| 104 | 3.27 | 1377 | 2.37 | Y | 19 | 12 |

Elements 101-104 demonstrate that useful levels of Visual Dmax (3.27 to 4.7) are currently accessible with commercially available relatively high silver coverage (greater than 1350 mg/m²) films that have efficiencies below 2.5 when processed with standard color print development process ECP-2D.

TABLE 1C
Elements 105-110 processed in the ECP-2D Process

| | | | | | Color | Color |
|---|---|---|---|---|---|---|
| | | | | | Balance | Balance |
| | | Silver | | Visual | (cyan/ | (yellow/ |
| | Visual | Content | | Dmin | magenta) | magenta) |
| Elem. | Dmax | (mg/m2) | Efficiency | <0.1 | percent | percent |
| 105 | 3.54 | 1471 | 2.41 | Y | 0.3 | 4.4 |
| 106 | 2.99 | 1208 | 2.48 | Y | 2.4 | 10 |
| 107 | 2.86 | 1144 | 2.50 | Y | 0.1 | 11 |
| 108 | 2.64 | 1070 | 2.47 | Y | 9.3 | 13 |
| 109 | 2.04 | 818 | 2.49 | Y | 0.3 | 10 |
| 110 | 1.20 | 490 | 2.45 | Y | 0.5 | 8.2 |

The data in Table 1C for Elements 105-110 demonstrates that only Element 105, which has a relatively high total silver level, has acceptable visual Dmax, visual Dmin and color balance performance. Although elements 106-110 have sufficiently low Dmin values (<0.1) and acceptable END color balance (cyan and yellow records within 20% or most preferably 10% of the magenta), the Dmax values are too low, not even reaching 3.3. It would be desirable to be able to develop such relatively lower silver films because the reduced silver content makes the bleaching and fixing of such films easier, in addition to reducing the cost of materials used to make the film.

### EXAMPLE 2

Relatively Low Silver Elements Developed in Developer I and Amplifier I; Relatively High Silver Elements also Developed in Developer I.

Elements 105-110 were processed according to an amplified development process comprising a Color Developer I step (1′), an Amplifier I step (1′), stop bath (40″), wash (40″), bleach accelerator (20″), persulfate bleach (40″), wash (40″), fix (40″), wash (1′), final rinse (10″), and then drying with hot air. Processing of the exposed elements is done with the color developing and amplifier solutions adjusted to 36.7° C. (98 F). The stopping, fixing, bleaching, washing, and final rinsing solution temperatures are adjusted to 26.7° C. (80 F).

The Color Developer I comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Sodium sulfite (anhydrous) | 4.35 | g |
| Sodium bromide (anhydrous) | 1.3 | g |
| Sodium carbonate (anhydrous) | 17.1 | g |
| Kodak Color Developing Agent, CD-2 | 3.1 | g |
| Sulfuric acid (7.0N) | 0.62 | mL |
| Water to make 1 liter | | |
| pH @ 26.7° C. is 10.65 +/− 0.05 | | |

The Amplifier I comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Sodium carbonate (anhydrous) | 17.1 | g |
| H2O2 (30%) | 12 | g |
| Color Developer I solution | 80 | mL |
| Water to make 1 liter | | |
| pH @ 26.7° C. is 10.8 +/− 0.05 | | |

After processing, the visual density and efficiency were measured as described above, and the results are presented in Table 2A.

TABLE 2A

| | | | | Ag/Coup | | Visual | | Total | |
|---|---|---|---|---|---|---|---|---|---|
| | Color | Silver | Coup | Equiv | END | Dmin | Visual | Silver | |
| Elem. | Rec. | mg/m² | mg/m² | mol ratio | Dmax | <0.1 | Dmax | mg/m² | E |
| 105 | Green | 440 | 648 | 0.97 | 4.05 | Y | 3.94 | 1471 | 2.68 |
| | Red | 396 | 888 | 1.06 | 3.69 | | | | |
| | Blue | 635 | 1316 | 1.46 | 3.90 | | | | |
| 106 | Green | 368 | 619 | 0.85 | 4.06 | Y | 3.92 | 1208 | 3.25 |
| | Red | 330 | 844 | 0.93 | 3.65 | | | | |
| | Blue | 510 | 1258 | 1.23 | 3.77 | | | | |
| 107 | Green | 342 | 648 | 0.76 | 4.06 | Y | 3.91 | 1144 | 3.42 |
| | Red | 308 | 888 | 0.82 | 3.65 | | | | |
| | Blue | 494 | 1316 | 1.14 | 3.82 | | | | |
| 108 | Green | 339 | 664 | 0.73 | 3.80 | Y | 3.80 | 1070 | 3.55 |
| | Red | 279 | 817 | 0.81 | 3.70 | | | | |
| | Blue | 452 | 1304 | 1.05 | 3.79 | | | | |
| 109 | Green | 245 | 648 | 0.54 | 3.51 | Y | 3.73 | 817 | 4.57 |
| | Red | 220 | 888 | 0.59 | 3.63 | | | | |
| | Blue | 353 | 1316 | 0.81 | 3.59 | | | | |
| 110 | Green | 147 | 648 | 0.32 | 2.75 | Y | 2.70 | 490 | 5.51 |
| | Red | 132 | 843 | 0.37 | 2.57 | | | | |
| | Blue | 212 | 1304 | 0.49 | 2.71 | | | | |

While relatively low silver elements 106-110 do not meet the desired visual Dmax criteria when developed in the ECP-2D process as demonstrated in Example 1, Table 2A shows that visual densities at Dmax of at least 3.3 can be easily achieved for print elements 106-109 having total silver level above 500 mg/m², with efficiencies between 2.5 and 6.7, by employing an Amplifier I step in combination with Color Developer I step. All of the examples also have adequate color balance with the END Dmax of the red and blue records within 20% of the END Dmax of the green record. Element 108 demonstrates that changes to the distribution of the silver and coupler between the red, green, and blue sensitive layers, as well as the ratio of emulsion types may be used to adjust the color balance at Dmax.

Data for Element 105 in Table 2A also demonstrates that good performance may be achieved for use of the combination of Color Developer I and Amplifier I for relatively higher silver elements. A particular advantage of the invention, however, allows for non-amplified development of relatively high silver elements while employing the same developer solution used for amplified development of relatively low silver elements. Table 2B contains the results of the use of Developer I in place of the standard ECP-2D developer when processing relatively high silver Element 101, using the processing sequence employed in Example 1 (i.e., 3 minute development, without use of a development amplification step).

TABLE 2B
High silver Element 101 developed in Developer I

| | | | | | Color | Color |
|---|---|---|---|---|---|---|
| | | | | | Balance | Balance |
| | | Silver | | Visual | (cyan/ | (yellow/ |
| Ele- | Visual | Content | | Dmin | magenta) | magenta) |
| ment | Dmax | (mg/m2) | Efficiency | <0.1 | percent | percent |
| 101 | 3.75 | 1636 | 2.29 | Y | 2.6 | 1.7 |

The inventive process provides a method for processing of low silver photographic materials capable of producing satisfactory images during cinematographic projection, employing a color developer solution which is also compatible with processing of conventional relatively high silver photographic materials. The same processing equipment may be employed for processing of both such types of print films without adjustment to the solutions using, e.g., a mechanical cutover method in which high silver films may be simply re-spliced to skip the amplification solution and the processor slowed to allow a longer time in the developer. The process permits flexibility in commercial operations to practice both amplified and unamplified processes with minimal disruption. In addition, Developer I requires no new chemicals and has modest excursions in the levels of the chemicals compared to the standard ECP-2D developer formulation. This makes a transition to the new process easy for commercial laboratories.

### EXAMPLE 3

Processing Conditions that may be used to Obtain Acceptable Results with Relatively High Silver Films.

This example demonstrates the preferred formulation limits for Color Developer solutions to properly process relatively high silver elements to adequate visual Dmax, visual Dmin and color balance, without requiring development amplification. Element 101 was processed in a rack and tank processor in developers adjusted to the levels of the chemical components as described in Table 3. In each case the components in the formula, time, and temperature that are not specified were set to the ECP-2D specifications.

It is well known in the art that the processing conditions of the ECP-2D developer may be modified with acceptable sensitometric results. The H-24 Manual Module 10: Effects of Mechanical and Chemical Variations in Process ECP-2D includes data that demonstrates the range of processing conditions that are considered to be within very tight control limits. This example demonstrates that a wide range of chemical and mechanical ranges can give acceptable visual Dmax, visual Dmin and color balance.

Several of the chemical components have very little effect on the visual Dmin, visual Dmax and color balance. Since the carbonate is present as a buffer, it must be sufficient to maintain the desired pH, but a wide range of concentrations is acceptable. The sulfite acts as an anti-oxidant, and should be present in sufficient amounts to prevent the degradation of the CD-2, but even its removal has very little effect on the Dmax in a rack-and-tank process. Increasing the CD-2 is possible, but no benefit is obtained, and eventually the solubility limit is reached.

However, sodium bromide must be present in the developer, and the minimum variability detectable with standard analytical techniques for processing labs as described in the H-24 publication is above 0.1 g/l. At 0.1 g/l of sodium bromide, the visual Dmin of film Element 101 was 0.1, just at the acceptable limit. When the sodium bromide was removed completely the visual Dmin was 0.43, which is unacceptable. In addition, the pH of the developer must be above 9.5, and there are preferred limits on the two primary mechanical factors: the time of development should be above 1 minute (to provide desired Dmax), and the temperature of the developer above 86 F (to provide desired color balance).

TABLE 3
Variations of Color Developer

| | | | Color | Color | |
|---|---|---|---|---|---|
| | | | Balance | Balance | |
| | Developer formula | | cyan/ | yellow/ | visual |
| | ECP-2D with the | visual | magenta | magenta | Dmin |
| Elem. | changes below | Dmax | percent | percent | <0.10 |
| 101 | pH = 9.5 | 2.58 | −7.50 | 72.8 | Y |
| 101 | pH = 10 | 3.43 | 1.00 | 15.3 | Y |
| 101 | pH = 10.4 | 3.68 | 0.17 | 3.42 | Y |
| 101 | pH = 10.9 | 3.78 | 2.94 | 0.11 | Y |
| 101 | pH = 11.0 | 3.81 | −4.60 | −0.60 | Y |
| 101 | pH = 11.5 | 3.85 | −3.60 | −4.80 | Y |
| 101 | CD-2 = 2.1 g/l | 3.65 | 2.12 | 0.91 | Y |
| 101 | CD-2 = 3.7 g/l | 3.75 | 3.01 | 2.99 | Y |
| 101 | NaBr = 0.0 g/l | 3.49 | 1.16 | −2.50 | N |
| 101 | NaBr = 0.1 g/l | 3.61 | 0.05 | −4.37 | Y |
| 101 | NaBr = 0.5 g/l | 3.72 | 0.62 | 0.43 | Y |
| 101 | NaBr = 2.1 g/l | 3.76 | 2.90 | 2.60 | Y |
| 101 | NaBr = 2.5 g/l | 3.73 | −2.00 | 3.70 | Y |
| 101 | NaBr = 3.5 g/l | 3.75 | −2.80 | 3.70 | Y |
| 101 | Sodium sulfite = 0.0 g/l | 3.91 | 12.1 | 15.6 | Y |
| 101 | Sodium sulfite = 1.0 g/l | 3.86 | −7.80 | 8.30 | Y |
| 101 | Sodium sulfite = 3.5 g/l | 3.83 | 4.08 | 3.85 | Y |
| 101 | Sodium sulfite = 4.5 g/l | 3.74 | 2.33 | 1.92 | Y |
| 101 | Sodium sulfite = 7.0 g/l | 3.67 | 0.50 | −0.90 | Y |
| 101 | Carbonate = 11 g/l | 3.71 | −2.10 | 4.20 | Y |
| 101 | Carbonate = 25 g/l | 3.75 | −3.50 | 2.50 | Y |
| 101 | Time = 1 min | 3.14 | 3.70 | 6.00 | Y |
| 101 | Time = 2 min | 3.69 | −0.30 | 3.90 | Y |
| 101 | Temp = 86 F. | 3.35 | −5.50 | 25.5 | Y |
| 101 | Temp = 90 F. | 3.63 | −0.30 | 6.90 | Y |

### EXAMPLE 4

Preferred Ranges of Composition and Mechanical Parameters for Color Developer and Amplifier Solutions to Develop Low Silver Films.

This example demonstrates the preferred formulation limits for combinations of Color Developer and Amplifier solutions to properly process low silver elements to adequate visual Dmax, visual Dmin and color balance.

Element 107 was processed in a rack and tank processor in developers adjusted to the levels of the chemical components as described in Table 4A. In each case in Table 4A, Amplifier I was used with the addition of the appropriate Developer as carryover. The processing time was 1 minute in the developer, 1 minute in the amplifier, and the temperature of both solutions was 36.6° C. (98 F). The data in Table 4A demonstrates that only a restricted range of color developer and bromide concentrations gives adequate results and that all levels of sulfite and pH that were tested gave adequate results. In all cases the color balance was within the preferred limits.

Element 107 was processed in a rack and tank processor in amplifier solutions adjusted to the levels of the chemical components as described in Table 4B. For this comparison Developer I was used in each case. The processing time was 1 minute in the developer, 1 minute in the amplifier, and the temperature of both solutions was 36.6 ° C. (98 F). In all cases in Table 4B the END Dmax color balance was within the preferred limits. The data in Table 4B demonstrates that the pH of the amplifier has very little effect over a wide range, a minimum amount of carryover is useful to restrain the Dmin, and the H₂O₂ level should be above 5 g/l for rack and tank processing. Data in a later example, however, demonstrates that lower H₂O₂ levels may be used effectively in other circumstances.

The ranges of mechanical parameters for the process listed in Table 4C were tested using Developer I and Amplifier I to develop Element 107. The color balance for all conditions in Table 4C was within the preferred limits. The data in Table 4C demonstrates that the residence time of the film preferably should be at least 45 seconds in either the developer or the amplifier in order to reach an acceptable visual Dmax. All of the temperatures that were tested resulted in acceptable film performance.

TABLE 4A
Chemical variations of Color Developer I.

| | Developer I with the | visual | visual Dmin |
|---|---|---|---|
| Element | changes below | Dmax | <0.10 |
| 107 | Sodium sulfite = 0.0 g/l | 4.01 | Y |
| 107 | Sodium sulfite = 7.0 g/l | 3.96 | Y |
| 107 | Sodium sulfite = 15.0 g/l | 3.92 | Y |
| 107 | pH = 10 | 3.92 | Y |
| 107 | pH = 11.0 | 4.00 | Y |
| 107 | pH = 11.5 | 4.01 | Y |
| 107 | CD-2 = 2.1 g/l | 3.20 | Y |
| 107 | CD-2 = 2.5 g/l | 3.47 | Y |
| 107 | CD-2 = 2.9 g/l | 3.63 | Y |
| 107 | CD-2 = 3.1 g/l | 3.80 | Y |
| 107 | CD-2 = 3.7 g/l | 3.81 | Y |
| 107 | NaBr = 0.3 g/l | 4.04 | N |
| 107 | NaBr = 0.5 g/l | 3.87 | Y |
| 107 | NaBr = 0.9 g/l | 3.77 | Y |
| 107 | NaBr = 1.3 g/l | 3.73 | Y |
| 107 | NaBr = 1.7 g/l | 3.61 | Y |
| 107 | NaBr = 2.1 g/l | 3.38 | Y |
| 107 | Carbonate = 21 g/l | 3.99 | Y |
| 107 | Carbonate = 25 g/l | 4.00 | Y |

TABLE 4B
Chemical variations of Amplifier I.

| | | visual | visual Dmin |
|---|---|---|---|
| Element | Process Condition | Dmax | <0.10 |
| 107 | Carryover (ml/l) = 0 | 3.98 | N |
| 107 | Carryover (ml/l) = 10 | 4.03 | Y |
| 107 | Carryover (ml/l) = 150 | 3.96 | Y |
| 107 | pH = 10 | 3.83 | Y |
| 107 | pH = 11.0 | 4.02 | Y |
| 107 | pH = 11.5 | 3.96 | Y |
| 107 | H₂O₂ = 5 g/l | 3.12 | Y |
| 107 | H₂O₂ = 10 g/l | 3.71 | Y |
| 107 | H₂O₂ = 15 g/l | 3.67 | Y |
| 107 | H₂O₂ = 20 g/l | 3.65 | Y |
| 107 | H₂O₂ = 30 g/l | 3.97 | Y |
| 107 | H₂O₂ = 40 g/l | 3.97 | Y |

TABLE 4C
Processing mechanical variables.

| | | | Developer | | | visual |
|---|---|---|---|---|---|---|
| | Developer | Amplifier | Temp. | Amplifier | visual | Dmin |
| Elem. | Time (s) | Time (s) | ° F. | Temp. ° F. | Dmax | <0.10 |
| 107 | 45 | 45 | 98 | 98 | 3.24 | Y |
| 107 | 60 | 45 | 98 | 98 | 3.54 | Y |
| 107 | 45 | 60 | 98 | 98 | 3.41 | Y |
| 107 | 60 | 60 | 98 | 98 | 3.73 | Y |
| 107 | 75 | 75 | 98 | 98 | 3.71 | Y |
| 107 | 60 | 60 | 90 | 90 | 3.71 | Y |
| 107 | 60 | 60 | 94 | 94 | 3.89 | Y |
| 107 | 60 | 60 | 98 | 98 | 3.73 | Y |
| 107 | 60 | 60 | 102 | 102 | 3.54 | Y |

The inventive process is designed to be able to process both high and low silver films, so the preferred limitations of the process are a combination of those for the high silver films and low silver films. Using the data from Tables 3And 4A-4C, the minimum acceptable chemical and mechanical ranges for the inventive process are that the CD-2 color developing agent concentration in the developer must be greater than 2.1 g/l, the sodium bromide level in the developer must be greater than 0.3 g/l and less than 2.1 g/l, and the developer pH must be greater than 9.5. In addition, color developing agent and bromide must be present in the amplifier solution along with an oxidizing agent. Further, the time in the developer or amplifier should preferably be greater than 45 s. In order to reach preferred higher visual Dmax, the CD-2 level in the developer needs to be higher, preferably above 2.9 g/l, the H2O2 concentration in the amplifier should be greater than 5 g/l, more preferably greater than 10 g/l, and the time in the developer should be greater than or equal to 60 s. The bromide level in the developer must also be restricted to below 1.7 g/l. Most preferably, the CD-2 should be raised to 3.1 g/l to insure that given the analytical limits for measuring CD-2 (±0.25 g/l) the level will be greater than 2.9 g/l, and the bromide level in the developer should be at or lower than 1.3 g/l, since bromide tends to season out of films and the level will normally rise in continuous usage. The H₂O₂ concentration in the amplifier should be greater than or equal to 12 g/l to allow for the natural degradation of H₂O₂ over time, and the time in the developer should be at least 60 s.

### EXAMPLE 5

Combinations of Changes in the Developer and Amplifier may Allow Even Very Low Silver Films to Reach Acceptable Dmax.

Combinations of the chemical and mechanical conditions in a process may enhance the activity of the process for a particular film. Element 110 when processed through Developer I alone results in too low Dmax values, and it has an undesirably low Dmax value even when processed in combination with Amplifier I. The data in Table 5A below demonstrates that it is possible to raise the Dmax to be within the minimally desired range by reducing the amount of carryover in the amplifier, and even into the preferred range of Dmax by combining the most active processing conditions from Tables 3 and 4A-4C. In each case in Table 5A the film was processed for 1 minute in the developer and 1 minute in the amplifier, with both solutions at 36.6° C. In each case the color balance was within the preferred limits, and the visual Dmin is below 0.10.

TABLE 5A
Developer for 1 minute at 36.6° C., Amplifier for 1 minute at 36.6° C.
with the listed deviations from Developer I and Amplifier I.

| | Sulfite | Developer | CD-2 | Bromide | Carryover | Amplifier | H₂O₂ | visual |
|---|---|---|---|---|---|---|---|---|
| Elem. | (g/l) | pH | (g/l) | (g/l) | (ml/l) | pH | (g/l) | Dmax |
| 110 | 4 | 10.65 | 3.1 | 1.3 | 20 | 10.8 | 12 | 3.35 |
| 110 | 4 | 10.65 | 3.1 | 1.3 | 100 | 10.8 | 12 | 2.54 |
| 110 | 4 | 10.65 | 3.1 | 1.3 | 80 | 10.8 | 12 | 2.70 |
| 110 | 4 | 10.65 | 3.1 | 2.1 | 80 | 10.8 | 12 | 2.22 |
| 110 | 4 | 10.65 | 3.7 | 1.3 | 10 | 10.8 | 15 | 3.74 |

Although the extreme sensitivity of the low silver Element 110 to the developer and amplifier chemistry allows a high Dmax to be reached, the variability of the Dmax as a result of even small changes in developer and amplifier chemistry makes this formulation less desirable. For example, when element 107 is developed with a range of carryover in the amplifier from 10-150 ml/l, the visual Dmax is relatively robust, whereas element 110 changes by 0.8 over a narrower range of 20-100 ml/l. Element 110 is similarly much more sensitive to the sodium bromide concentration in the developer.

As a further example, Elements 109 and 110 were processed similarly as described in Example 2, except employing Color Developer II in place of Color Developer II, and Amplifier II in place of Amplifier I.

Color Developer II comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Sodium sulfite (anhydrous) | 4.35 | g |
| Sodium bromide (anhydrous) | 0.5 | g |
| Sodium carbonate (anhydrous) | 17.1 | g |
| Kodak Color Developing Agent, CD-2 | 3.7 | g |
| Sulfuric acid (7.0N) | 0.62 | mL |
| Water to make 1 liter | | |
| pH @ 26.7° C. is 10.65 +/− 0.05 | | |

The Amplifier II comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Sodium carbonate (anhydrous) | 17.1 | g |
| H2O2 (30%) | 15 | g |
| Color Developer I | 10 | mL |
| Water to make 1 liter | | |
| pH @ 26.7° C. is 10.8 +/− 0.05 | | |

The results obtained are reported in Table 5B:

TABLE 5B

| Elem | Visual Dmax | Silver Content (mg/m2) | Efficiency |
|---|---|---|---|
| 110 | 3.78 | 490 | 7.71 |
| 109 | 3.94 | 817 | 4.82 |

The above data further demonstrates that process changes may be used to enhance the efficiency of elements with the lowest silver content. By altering the process, the efficiency of element 110, e.g., may be increased until the visual Dmax is within the desired range for a print film. Again, however, while processing of Element 109 employing total silver level of at least 500 mg/m² in accordance with preferred embodiments of the invention demonstrates some process dependency, it does so to a much less extent than that of element 110 employing total silver level below 500 mg/m².

### EXAMPLE 6

Comparable Activities may also be Achieved with a Continuous Process

In order to enable commercial operations of continuous motion picture print film processors to capture the advantages of development amplification, the process must be able to be run at high rates (e.g., processing speeds of at least 100 ft/minute) with high ratios of the volume of the processing solution tanks to the area of film (conventional motion picture processors typically have ratios of over 100). Color paper redox amplification processes employing low volume thin tank (LVTT) processors, on the other hand, typically cite a preferred volume to area ratio of less than 3 dm³/m².

Elements 107 and 108 were processed in a rack and tank process as described in Example 2, and a continuous Filmlab Processor at 100 ft/minute with a ratio of tank volume/film area of 126. The process sequence for this inventive example consists of Color Developer III (1′), Amplifier III (45s), stop bath (40″), first wash (40″), first fix (40″), second wash (40″), bleach accelerator (20″), persulfate bleach (40′), third wash (40″), second fix (40″), fourth wash (1′), final rinse (10″), and then drying with hot air. Processing of the exposed elements is done with the color developer solution adjusted to 36.7° C., and the amplifier solution adjusted to (35.5° C.). The stopping, fixing, bleaching, washing, and final rinsing solution temperatures are adjusted to 26.7° C.

The Color Developer III comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Hydroxylamine sulfate | 2.79 | g |
| Sodium bromide (anhydrous) | 1.32 | g |
| Sodium carbonate (anhydrous) | 17.1 | g |
| Kodak Color Developing Agent, CD-2 | 3.18 | g |
| Water to make 1 liter | | |
| pH @ 26.7° C. is 10.63 +/− 0.05 | | |

The Amplifier III comprises:

| | | |
|---|---|---|
| Kodak Anti-Calcium, No. 4 (40% solution of a pentasodium | 1.00 | mL |
| salt of nitrilo-tri(methylene phosphonic acid) | | |
| Sodium carbonate (anhydrous) | 17.1 | g |
| H2O2 (30%) | 1.5 | g |
| Color Developer III | 10 | mL |
| Water to make 1 liter | | |
| pH @ 26.7° C. is 10.76 +/− 0.05 | | |

TABLE 6
Comparison of Batch Rack and Tank and Continuous Processors

| | | | | | Color | Color |
|---|---|---|---|---|---|---|
| | | | Dev/ | | Balance | Balance |
| | Silver | | Amp | | (cyan/ | (yellow/ |
| | Content | | So- | visual | magenta) | magenta) |
| Elem. | (mg/m²) | Process | lutions | Dmax | percent | percent |
| 107 | 1144 | Batch R&T | I/I | 3.91 | 10.1 | 5.9 |
| 107 | 1144 | Batch R&T | II/II | 3.99 | 9.1 | 3.1 |
| 107 | 1144 | Continuous | II/II | 3.91 | 10.7 | 9.4 |
| 108 | 1070 | Batch R&T | I/I | 3.80 | 2.6 | 0.2 |
| 108 | 1070 | Continuous | II/II | 3.74 | 0.0 | 6.2 |

The data in Table 6 demonstrates that the inventive process is consistent with current high volume processing equipment. In addition it shows that the antioxidant in the developer is not restricted to sodium sulfite; hydroxylamine sulfate was used in this case, as well as substantially lower levels of H₂O₂. In all cases the visual Dmin was below 0.10.

### EXAMPLE 7

Color print film Elements 106-109 described in Example 2 are imagewise exposed in accordance with desired image area frames, and the cyan dye forming layer is exposed in accordance with a variable area analog soundtrack. The exposed films are then processed according to the amplified development process described in Example 2 to yield corresponding dye images in the image area frames, and a dye-only, silverless analog soundtrack. The films yield acceptable results for sensitometry, halation latitude, sharpness, and graininess. The film also yields acceptable audio performance for a dye-only soundtrack.

While the invention has been described in detail with particular reference to preferred embodiments, it will be understood that variations and modifications can be effected within the spirit and scope of the invention.

1. A method for processing imagewise exposed silver halide light sensitive motion picture photographic print film elements, the method comprising:
i) classifying imagewise exposed print film elements containing cyan, magenta and yellow dye-forming couplers present at levels sufficient to provide Visual densities of at least 3.3 when completely consumed as either a relatively high silver containing element or a relatively low silver containing element;
ii) providing a developer solution comprising greater than 2.1 g/l Color Developing Agent CD-2, greater than 0.3 and less than 2.1 g/l of Sodium Bromide (Anhydrous), and a buffering agent to maintain pH in the range of from about 10 to about 12;
iii) developing imagewise exposed print film elements which have been classified as relatively low silver containing elements in a development step wherein the exposed print film is first processed in the developer solution provided in step ii) above, and in a subsequent development amplification step wherein the exposed print film is processed in an amplifier solution comprising bromide salt and an oxidizing agent; and
iv) developing imagewise exposed print film elements which have been classified as relatively high silver containing elements in a development step wherein the exposed print film is processed in the developer solution provided in ii) above.

2. A method according to claim 1, wherein print film elements which have been classified as relatively high silver containing elements and which have been imagewise developed in step iv) by processing in the developer solution provided in ii) are not subjected to a subsequent development amplification step as defined in step iii).

3. A method according to claim 1, wherein the developer solution comprises at least 3.1 g/l Color Developing Agent CD-2.

4. A method according to claim 1, wherein the developer solution comprises from 0.5 to 1.7 g/l of Sodium Bromide (anhydrous).

5. A method according to claim 1, wherein the developer solution comprises from 0.5 to 1.3 g/l of Sodium Bromide (anhydrous).

6. A method according to claim 1, wherein the developer solution comprises an antioxidant.

7. A method according to claim 6, wherein the antioxidant comprises Sodium Sulfite.

8. A method according to claim 1, wherein the buffering agent comprises Sodium Carbonate.

9. A method according to claim 1, wherein the amplifier solution comprises hydrogen peroxide.

10. A method according to claim 1, wherein the amplifier solution comprises from 0.3 to 12 g of H₂O₂ per liter.

11. A method according to claim 1, wherein the amplifier solution comprises from about 10 to 150 g/l of the developer solution provided in step ii).

12. A method according to claim 1, wherein print films having a total silver level of at least 1350 mg/m² are classified as relatively high silver containing elements, and print films having a total silver level of less than 1350 mg/m² are classified as relatively low silver containing elements in step i).

13. A method according to claim 12, wherein imagewise exposed print film elements which have been classified as relatively low silver containing elements are processed in the developer solution for at least 45 seconds at a temperature of at least 90 F, and subsequently processed in the amplifier solution for at least 45 seconds at a temperature of at least 90 F.

14. A method according to claim 12, wherein imagewise exposed print film elements which have been classified as relatively high silver containing elements are processed in the developer solution for longer than 1 minute at a temperature of at least 90 F.

15. A method according to claim 12, wherein imagewise exposed print film elements which have been classified as relatively low silver containing elements are processed in the developer solution for from 45 to 90 seconds at a temperature of from 90 to 102 F, and subsequently processed in the amplifier solution for from 45 to 90 seconds at a temperature of from 90 to 102 F, and wherein imagewise exposed print film elements which have been classified as relatively high silver containing elements are processed in the developer solution for from about 2 to 3 minutes at a temperature of from 90 to 102 F.

16. A method according to claim 1, wherein the print film elements comprise a support bearing on one side thereof: a blue color sensitive, yellow dye image-forming record comprising at least one blue-sensitive silver halide emulsion having associated therewith yellow dye-forming coupler; a red color sensitive, cyan dye image-forming record comprising at least one red-sensitive silver halide emulsion having associated therewith cyan dye-forming coupler; and a green color sensitive, magenta dye image-forming record comprising at least one green-sensitive silver halide emulsion having associated therewith magenta dye-forming coupler; each of the silver halide emulsions have an average grain size of less than 1 micrometer and comprise at least 50 mol percent chloride, based on silver; the silver halide emulsions of relatively low silver containing elements in total comprise less than 1350 mg/m² silver, and the silver halide emulsions of relatively high silver containing elements in total comprise at least 1350 mg/m² silver; and the silver to dye-forming coupler stoichiometric equivalent molar ratio in each of the image-forming records of a relatively low silver containing element developed in step iii) is less than 1.4, and the silver to dye-forming coupler stoichiometric equivalent molar ratio in at least one of the image-forming records of the relatively low silver containing element processed in step iii) is less than 1.0.

17. A method according to claim 16, wherein maximum visual densities of at least 3.3 are obtained for both relatively high silver containing elements processed in step iv) and relatively low silver containing elements processed in step iii).

18. A method according to claim 16, wherein maximum visual densities of at least 3.6 are obtained for both relatively high silver containing elements processed in step iv) and relatively low silver containing elements processed in step iii).

19. A method according to claim 16, wherein the Equivalent Neutral Density Dmax in the cyan and yellow color records of both relatively high silver containing elements processed in step iv) and relatively low silver containing elements processed in step iii) are within 20% of the Equivalent Neutral Density Dmax in the green record.

20. A method according to claim 16, wherein the visual Dmin for both relatively high silver containing elements processed in step iv) and relatively low silver containing elements processed in step iii) is less than 0.1.
